(19) United States
(12) Patent Application Publication
(10) Pub. No.: US 2025/0059627 A1
(43) Pub. Date: Feb. 20, 2025

(54) SYSTEMS AND METHODS FOR RECOVERING RADIUM-226

(71) Applicant: RADTRAN LLC, Lakewood, CO (US)

(72) Inventor: Saleem S. Drera, Lakewood, CO (US)

(21) Appl. No.: 18/938,772

(22) Filed: Nov. 6, 2024

Related U.S. Application Data
(63) Continuation of application No. PCT/US2023/022281, filed on May 15, 2023.
(60) Provisional application No. 63/342,619, filed on May 16, 2022.

(51) Int. Cl. C22B 60/00; B01J 20/26; B01J 20/30; C22B 3/24; G21F 9/12

(52) U.S. Cl. CPC C22B 60/00; B01J 20/26; B01J 20/3071; C22B 3/24; G21F 9/12

(57) ABSTRACT

The present disclosure relates to systems and methods for recovering radium-226. In one embodiment, uranium ore and/or tailings are processed to achieve an aqueous solution comprising radium-226. A macrocyclic material may be used to sorb the radium-226 from the aqueous solution. The macrocyclic material may subsequently be exposed to a recovery solution, such as EDTA, to recover the radium-226.

### CROSS-REFERENCE TO RELATED APPLICATION

This application is a continuation of International Patent Application No. PCT/US2023/022281, entitled “Systems and Methods for Recovering Radium-226,” filed May 15, 2023, which claims the benefit of U.S. Provisional Patent Application No. 63/342,619 entitled “Systems and Methods for recovering Radium-226” filed May 16, 2022. Each of the above-identified patent applications are hereby incorporated by reference in their entirety.

### BACKGROUND

Radium-226 or ²²⁶Ra occurs from the radioactive decay of uranium and thorium parents. Radium-226 is known to be a precursor for alpha-emitting isotopes, which may be useful for medical applications. See U.S. Patent Application Publication No. 2014/0226774.

### SUMMARY OF THE DISCLOSURE

Broadly, the present patent application relates to systems and methods for recovering radium-226, such as from uranium tailings and the like.

### BRIEF DESCRIPTION OF THE DRAWINGS

FIG. 1 illustrates one embodiment of a method for recovering radium-226 from a solution comprising radium-226.

FIG. 2 illustrates embodiments of the radium-226 solution of FIG. 1.

FIG. 3 illustrates embodiments of a macrocyclic polyether of the method of FIG. 1.

FIG. 4 illustrates embodiments of the recovery step of FIG. 1.

FIG. 5 illustrates embodiments of a preparing step that may be used to prepare a radium-226 containing solution for recovery.

FIG. 6 illustrates embodiments relating to uranium tailings effluents and recovery of radium-226.

### DETAILED DESCRIPTION

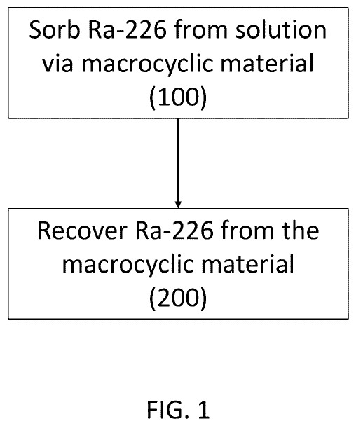

Referring now to FIG. 1, in one embodiment, a method for recovering radium-226 (“Ra-226”) from a solution comprises sorbing Ra-226 from an aqueous radium-containing solution via a macrocyclic solid-phase Ra-226 selective sorbent (100), and recovering Ra-226 from the macrocyclic solid-phase Ra-226 selective sorbent (200). The aqueous radium-containing solution may be any suitable aqueous solution comprising Ra-226. In some embodiments, and as described in further detail below, the aqueous solution is derived from uranium mining. In one embodiment, the aqueous solution is derived from uranium ore, such as from uranium tailings and the like. In another embodiment, the aqueous solution is, or is derived from, an ion exchange resin effluent, wherein an ion exchange resin is used to capture uranium from an aqueous stream comprising uranium.

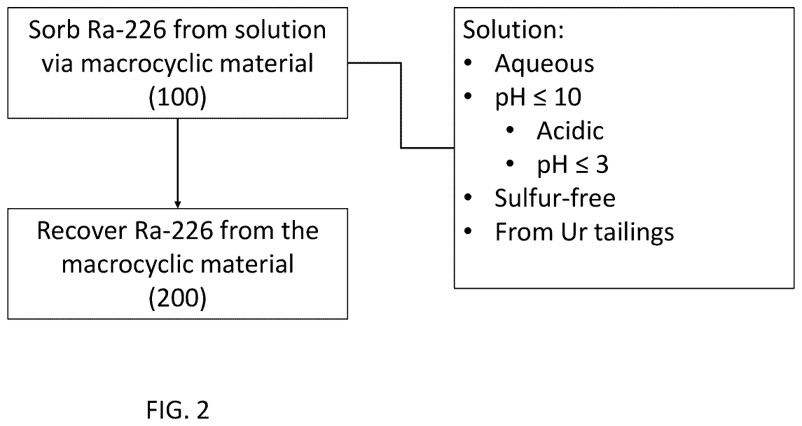

Referring now to FIGS. 1-2, in one embodiment, the aqueous radium-containing solution comprises a pH of not greater than 10. In another embodiment, the aqueous radium-containing solution comprises a pH of not greater than 9. In yet another embodiment, the aqueous radium-containing solution comprises a pH of not greater than 8. In another embodiment, the aqueous radium-containing solution comprises a pH of not greater than 7, e.g., is acidic. In yet another embodiment, the aqueous radium-containing solution comprises a pH of not greater than 6. In another embodiment, the aqueous radium-containing solution comprises a pH of not greater than 5. In yet another embodiment, the aqueous radium-containing solution comprises a pH of not greater than 4. In another embodiment, the aqueous radium-containing solution comprises a pH of not greater than 3.

In one embodiment, the aqueous radium-containing solution is an acidic solution comprising Ra-226 ions. In one embodiment, the aqueous radium-containing solution is selected from the group consisting of hydrochloric acid, nitric acid and combinations thereof, the solution comprising Ra-226 ions. In one embodiment, the aqueous radium-containing solution comprises or is a hydrochloric acid solution comprising Ra-226 ions. In another embodiment, the aqueous radium-containing solution comprises or is a nitric acid solution comprising Ra-226.

In one approach, during the sorbing step (100) the temperature of the aqueous radium-containing solution is from 1 to 75° C. In one embodiment, during the sorbing step (100) the temperature of the aqueous radium-containing solution is not greater than 60° C. In another embodiment, during the sorbing step (100) the temperature of the aqueous radium-containing solution is not greater than 50° C. In yet another embodiment, during the sorbing step (100) the temperature of the aqueous radium-containing solution is not greater than 40° C. In another embodiment, during the sorbing step (100) the temperature of the aqueous radium-containing solution is not greater than 35° C. In yet another embodiment, during the sorbing step (100) the temperature of the aqueous radium-containing solution is not greater than 30° C. In one embodiment, during the sorbing step (100) the temperature of the aqueous radium-containing solution is at least 5° C. In another embodiment, during the sorbing step (100) the temperature of the aqueous radium-containing solution is at least 10° C. In yet another embodiment, during the sorbing step (100) the temperature of the aqueous radium-containing solution is at least 15° C. In another embodiment, during the sorbing step (100) the temperature of the aqueous radium-containing solution is at least 20° C. In one approach, the sorbing step (100) is conducted at about ambient temperature.

In one embodiment, the aqueous radium-containing solution is free of sulfur, including trace or non-detectable levels of sulfur.

As noted above, the method generally comprises sorbing Ra-226 from an aqueous radium-containing solution. As used herein “sorbing” comprises both adsorbing and absorbing. In one embodiment, the sorbing step (100) comprises adsorbing Ra-226 via the macrocyclic solid-phase Ra-226 selective sorbent. In one embodiment, the sorbing step (100) comprises absorbing Ra-226 via the macrocyclic solid-phase Ra-226 selective sorbent.

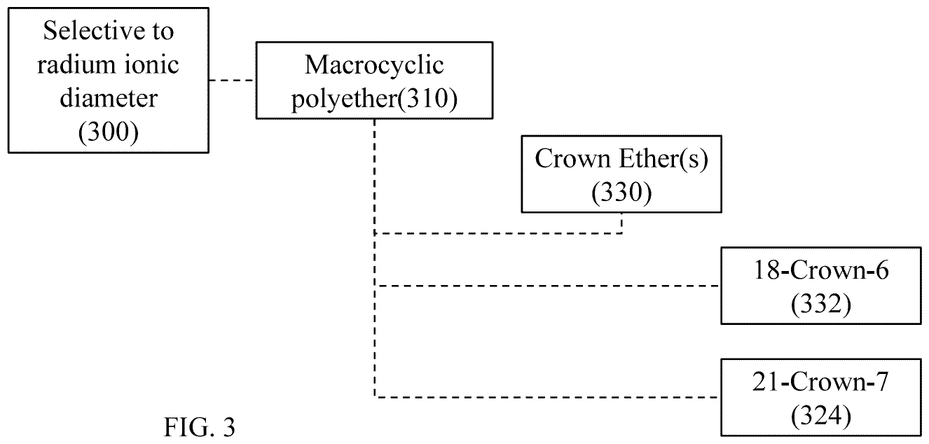

As noted above, the sorbing may be at least partially accomplished via a macrocyclic solid-phase Ra-226 selective sorbent. Referring now to FIG. 3, in one embodiment, the macrocyclic solid-phase Ra-226 selective sorbent is selective to the ionic diameter of radium (300). In one embodiment, the macrocyclic solid-phase Ra-226 selective sorbent is or comprises a macrocyclic polyether material (310). In one embodiment, the macrocyclic polyether material is or comprises a crown ether (330). In one embodiment, the crown ether is selected from the group consisting of 18-crown-6, 21-crown-7 and combinations thereof (332, 334).

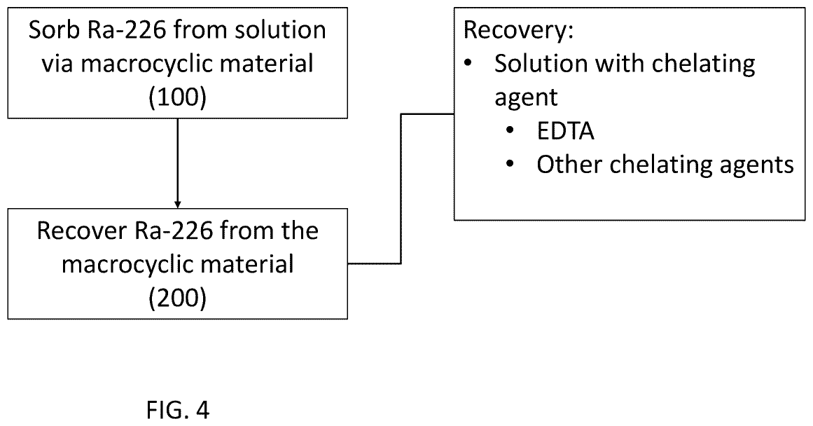

Referring now to FIG. 4, as noted above, a method may comprise recovering Ra-226 from the macrocyclic solid-phase Ra-226 selective sorbent (200). In one embodiment, the recovering step (200) comprises exposing the solid-phase Ra-226 selective sorbent to a recovery solvent. In one embodiment, the recovery solvent comprises a chelating agent. In one embodiment, the recovery solvent is or comprises EDTA (ethylenediaminetetraacetic acid [CH₂N(CH₂CO₂H)₂]₂). In another embodiment, the recover solvent is or comprises NTA (nitrilotriacetic acid [N(CH₂CO₂H)₃)]. EDTA and/or NTA may chelate Ra-226 cations, thereby desorbing them from the adsorbent. Other suitable extraction agents include diammonium hydrogen citrate, diethylenetriaminepentaacetic acid (DTPA), and combinations thereof, among others.

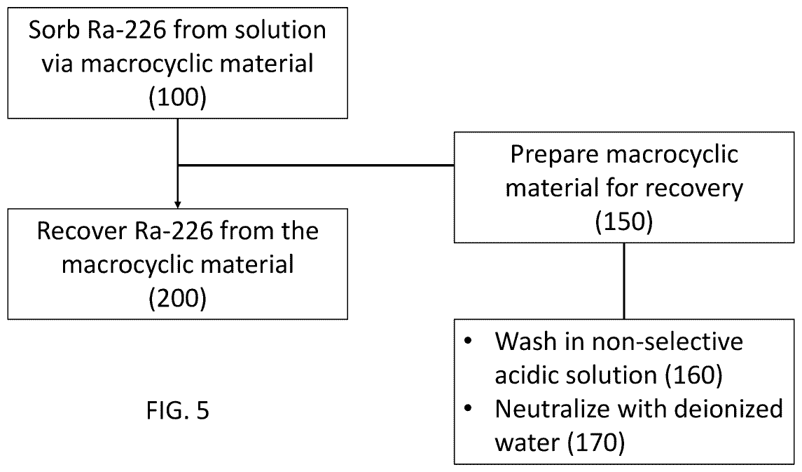

Referring now to FIG. 5, in one embodiment, a method may comprise preparing the macrocyclic material for recovery (150). Subsequently, the recovery step (200) may be completed. In one embodiment, the preparing step (150) comprises washing the macrocyclic material with a non-selective acidic solution (160), such as nitric acid. In one embodiment, the preparing step (150) comprises neutralizing the macrocyclic material with water, such as deionized water (170).

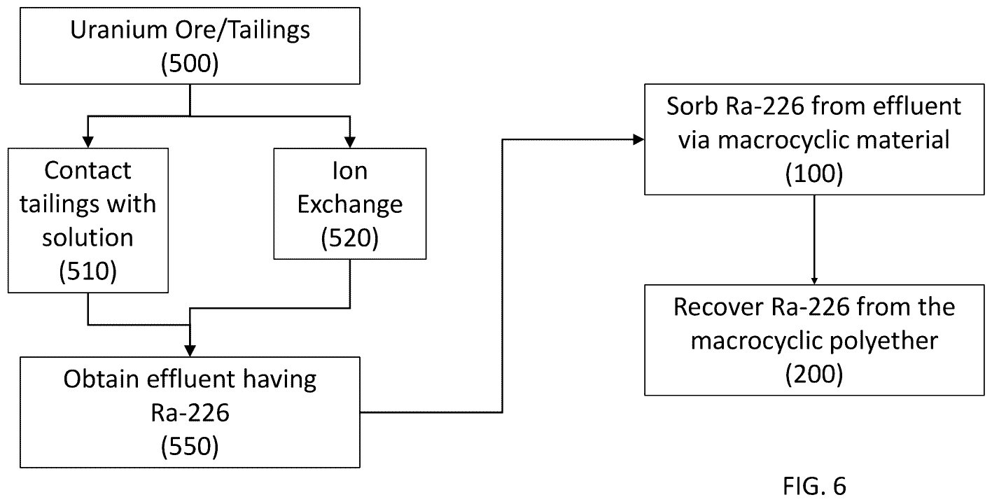

Referring now to FIG. 6, as mentioned above, the aqueous radium-containing solution may be derived from uranium mining and/or a uranium precursor. In one embodiment, a uranium precursor comprise uranium ore and/or tailings (500). In one embodiment, a method comprises converting at least some of the Ra-226 of the ore and/or tailings to soluble form. In one embodiment, the converting step (not illustrated) comprises contacting the uranium ore and/or tailings with a solution comprising a carbonate (e.g., sodium carbonate) to convert at least some of the radium-226 to a carbonate form. In one embodiment, after the converting step, a method may comprise contacting the uranium ore and/or tailings with a contacting solution (510), thereby producing a radium-containing effluent (520), which effluent may make up part of or the whole of the radium-containing solution of the sorbing step (100). In one embodiment, the contacting solution is or comprises an acid. In one embodiment, the acid is selected from the group consisting of hydrochloric acid, nitric acid and combinations thereof. In one embodiment, the acid is or comprises hydrochloric acid. In another embodiment, the acid is or comprises nitric acid. In another embodiment, the uranium ore and/or tailings are processed via a uranium ion recovery system, wherein the uranium ion recovery system comprises an ion exchange resin selective to uranium, wherein the radium-containing solution comprises an effluent of the uranium ion recovery system.

In one embodiment, a method comprises recovering Ra-226 from uranium ore and/or tailings by contacting the uranium ore and/or tailing with sulfuric acid. After the contacting step, at least some Ra-226 ions are contained in the sulfuric acid. A method may further comprise converting at least some of the Ra-226 of the sulfuric acid into carbonate form (e.g., RaCO₃), such as by adding sodium carbonate to the solution. Precipitated radium carbonate may then be recovered, such as by filtering. The radium carbonate may then be converting to ionic form, such as by dissolving the radium carbonate with nitric acid. The nitric acid may then be used as the aqueous radium-containing solution described above relative to step 100 of FIG. 1.

While various embodiments of the present disclosure have been described in detail, it is apparent that modifications and adaptations of those embodiments will occur to those skilled in the art. However, it is to be expressly understood that such modifications and adaptations are within the spirit and scope of the present disclosure.

What is claimed is:

1. A method comprising:
(a) sorbing Ra-226 from an aqueous radium-containing solution via a macrocyclic solid-phase Ra-226 selective sorbent; and
(b) recovering Ra-226 from the macrocyclic solid-phase Ra-226 selective sorbent.

2. The method of claim 1, wherein the solid-phase Ra-226 selective sorbent is selective to ions having a radium-consistent ionic diameter.

3. The method of claim 1, wherein the macrocyclic solid-phase Ra-226 selective sorbent comprises a macrocyclic polyether material.

4. The method of claim 3, wherein the macrocyclic polyether material is a crown ether.

5. The method of claim 4, wherein the crown ether is selected from the group consisting of 18-crown-6, 21-crown-7 and combinations thereof.

6. The method of claim 1, wherein the aqueous radium-containing solution comprises a pH of not greater than 10.

7. The method of claim 1, wherein the aqueous radium-containing solution is sulfur-free.

8. The method of claim 1, whereon the aqueous radium-containing solution is acidic.

9. The method of claim 8, wherein the aqueous radium-containing solution is selected from the group consisting of hydrochloric acid, nitric acid and combinations thereof.

10. The method of claim 1, wherein the recovering step (b) comprises exposing the solid-phase Ra-226 selective sorbent to a recovery solvent.

11. The method of claim 10, wherein the recovery solvent comprises a chelating agent.

12. The method of claim 10, wherein the recovery solvent comprises at least one of EDTA and NTA.

13. The method claim 1, comprising:
prior to the exposing step, washing the macrocyclic solid-phase Ra-226 selective sorbent with a non-selective acidic solution.

14. The method of claim 13, wherein the non-selective acidic solution comprises nitric acid.

15. The method of claim 13, comprising, after the washing step and prior to the exposing step, neutralizing the macrocyclic solid-phase Ra-226 selective sorbent with water.

16. The method of claim 15, wherein the water comprises deionized water.

17. The method of claim 1, wherein the aqueous radium-containing solution is derived from a uranium precursor.

18. The method of claim 17, wherein the uranium precursor comprises uranium tailings, and wherein the method comprises:
contacting the uranium tailings with an acid, thereby producing at least a portion of the radium-containing solution.

19. The method of claim 18, wherein the acid is selected from the group consisting of nitric acid, hydrochloric acid, sulfuric acid and combinations thereof.

20. The method of claim 17, comprising, prior to the contacting step, converting at least some Ra-226 of the uranium tailings to carbonate form.

21. The method of claim 17, wherein the uranium precursor comprises uranium tailings, wherein the uranium tailings are processed via a uranium ion recovery system comprises, wherein the radium-containing solution comprises an effluent of the uranium ion recovery system.
